(19) United States
(12) Patent Application Publication
(10) Pub. No.: US 2021/0255732 A1
(43) Pub. Date: Aug. 19, 2021

(54) FOLDABLE TOUCH SENSOR PANEL AND DISPLAY DEVICE THEREWITH

(71) Applicant: DONGWOO FINE-CHEM CO., LTD., Iksan-si (KR)

(72) Inventors: Ji-Yeon Kim, Pyeongtaek-si (KR); Dohyoung Kwon, Osan-si (KR); Ki Deok Lee, Osan-si (KR); Cheol Hun Lee, Pyeongtaek-si (KR)

(73) Assignee: DONGWOO FINE-CHEM CO., LTD., Iksan-si (KR)

(21) Appl. No.: 17/166,128

(22) Filed: Feb. 3, 2021

(30) Foreign Application Priority Data
Feb. 13, 2020 (KR) 10-2020-0017970

(51) Int. Cl. G06F 3/044

(52) U.S. Cl. CPC G06F 3/0443; G06F 3/0447

(57) ABSTRACT

A foldable touch sensor panel comprises: a touch sensor layer, a bonding layer having one side coupled to one side of the touch sensor layer and the other side coupled to a functional layer; and an adhesive layer having one side coupled to the other side of the touch sensor layer and the other side coupled to a display panel.

### CROSS REFERENCE TO RELATED APPLICATIONS

This application claims priority based on Korean Patent Application No. 10-2020-0017970, filed Feb. 13, 2020, the content of which is incorporated herein by reference in its entirety.

### TECHNICAL FIELD

The present invention relates to a foldable touch sensor panel. Specifically, the present invention relates to a foldable touch sensor panel capable of securing folding reliability.

### BACKGROUND ART

A display device is a device that displays information to the outside. The display device may include a liquid crystal display device, a plasma display panel device, an electroluminescent display device, an organic light-emitting diode display device, etc. The display device may include a touch sensor panel as a device for inputting commands by touching instructions displayed on a screen with a finger or a pen.

The touch sensor panel includes a resistive type, a capacitive type, an ultrasonic type, an infrared type, and so on, according to the sensing method of a touch part. Recently, the capacitive type is mainly used. The capacitive type uses a transparent substrate on which a conductive thin film is formed. When a user touches a surface of a coated transparent substrate with a certain amount of current flowing through the surface of the transparent substrate, the amount of current changes at the contact surface. The capacitive type can detect such a change in current to detect whether or not it is touched.

As a prior art, there is Korean Patent Laid-open Publication No. 2016-0131896 (polarizer integrated touch sensor and organic light emitting display device), etc. In the content of the prior art, a touch sensor panel having a polarizing plate and an electrode layer on one surface of a substrate is included. In the prior art, the sum of the thicknesses of the polarizing plate and the touch sensor is 30 to 300 μm, and the strength of the substrate is set to 1 MPa or more. Further, in the prior art, the touch sensor panel is combined with a display panel, a cover film (a kind of functional layer), and the like through an adhesive layer.

However, as in the prior art, if the touch sensor panel is combined with the display panel or the cover film (a kind of functional layer) through the adhesive layer, when the touch sensor panel is used for a foldable device, the electrode layer of the touch sensor panel may be disconnected.

### DISCLOSURE OF INVENTION

### Technical Problem

In order to solve such a problem of the prior art, the present invention is to prevent or minimize the occurrence of cracks in an electrode layer by increasing the folding reliability of a foldable touch sensor panel.

The present invention is to minimize the thickness of the touch sensor panel while maximizing the folding reliability of the foldable touch sensor panel.

### Technical Solution

A foldable touch sensor panel of the present invention for achieving the above object may comprise a touch sensor layer, a bonding layer, an adhesive layer, and so on.

The bonding layer may have one side coupled to one side of the touch sensor layer and the other side coupled to a functional layer.

The adhesive layer may have one side coupled to the other side of the touch sensor layer and the other side coupled to a display panel.

In the foldable touch sensor panel of the present invention, the bonding layer may have a modulus of 1 to 3 MPa at room temperature (25° C.) and a thickness of 1 to 3 μm.

In the foldable touch sensor panel of the present invention, the bonding layer may have a modulus of 1 to 2 MPa at room temperature (25° C.) and a thickness of 1.5 to 2 μm.

In the foldable touch sensor panel of the present invention, the adhesive layer may have a modulus of 0.02 to 0.5 MPa at room temperature (25° C.) and a thickness of 15 to 35 μm.

In the foldable touch sensor panel of the present invention, the adhesive layer may have a modulus of 0.02 to 0.3 MPa at room temperature (25° C.) and a thickness of 15 to 25 μm.

In the foldable touch sensor panel of the present invention, the functional layer may be a polarizing plate, and, in this case, the functional layer may have a thickness of 15 to 75 μm.

In the foldable touch sensor panel of the present invention, the functional layer may be a polarizing plate, and, in this case, the functional layer may have a thickness of 35 to 55 μm.

A display device according to the present invention may comprise the foldable touch sensor panel described above, and a display panel coupled to the other side of the adhesive layer of the foldable touch sensor panel.

### Advantageous Effects

In the present invention, the thickness and room temperature modulus of the bonding layer bonding the touch sensor layer and the functional layer are 1 to 3 μm and 1 to 3 MPa, respectively. Through this, the present invention can minimize the occurrence of cracks in the electrode layer of the touch sensor layer when the touch sensor is used for a foldable device.

In the present invention, the thickness and room temperature modulus of the adhesive layer bonding the touch sensor layer and the display panel are 15 to 35 μm and 0.02 to 0.5 MPa, respectively. Through this, the present invention can minimize the occurrence of cracks in the electrode layer of the touch sensor layer when the touch sensor is used for a foldable device.

In the present invention, the functional layer has a thickness of 15 to 75 μm. Through this, the present invention can minimize the occurrence of cracks in the electrode layer of the touch sensor layer when the touch sensor is used for a foldable device.

In addition, the present invention minimizes the thickness of the bonding layer, the adhesive layer, and the functional layer, and further, the touch sensor layer does not combine a separate base film other than the base of the electrode layer. Through this, in the present invention, the touch sensor layer can be thinned, and as a result, the foldable touch sensor panel can be made thinner.

### DESCRIPTION OF DRAWINGS

FIG. 1 is a cross-sectional view of a foldable touch sensor panel according to the present invention.

### BEST MODE

Hereinafter, the present invention will be described in detail with reference to the accompanying drawings.

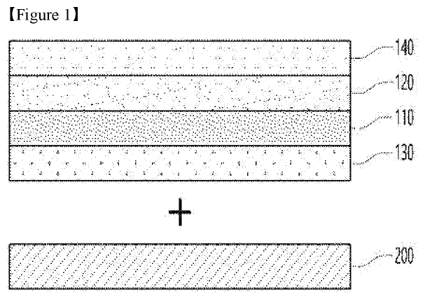

FIG. 1 is a cross-sectional view of a foldable touch sensor panel according to the present invention.

As shown in FIG. 1, the foldable touch sensor panel of the present invention may be composed of a touch sensor layer 110, a bonding layer 120, an adhesive layer 130, and so on. The present invention may combine a functional layer 140 or the like in such a configuration as a combined type or an integrated type. In addition, according to the present invention, a display device may be formed by combining a display panel 200 on one side of such configuration.

The touch sensor layer 110 may include a base layer, an electrode layer, a passivation layer, and so on.

The base layer is a base supporting the electrode layer. The base layer may be composed of, for example, a cyclo-olefin polymer (COP), polycarbonate, polyethylene terephthalate (PET), polymethyl methacrylate, polyimide, polyethylene naphthalate, polyether sulfone, etc.

The base layer may be a separation layer when the touch sensor panel is manufactured by a transfer method. As the separation layer, an organic polymer film may be used. For example, at least one selected from the group consisting of polyimide, poly vinyl alcohol, polyamic acid, polyamide, polyethylene, polystyrene, polynorbomene phenylmaleimide copolymer, polyazobenzene, polyphenylenephthalamide, polyester, polymethyl methacrylate, polyarylate, cinnamate polymer, coumarin polymer, phthalimidine polymer, chalcone polymer and aromatic acetylene polymer may be used as the separation layer.

The base layer may further have one or more protective layers on the separation layer. The protective layer protects the electrode layer against external contact or impact, and may reinforce the function of the separation layer. The protective layer may include at least one of an organic insulation layer or an inorganic insulation layer. The protective layer can be formed through coating/curing or deposition.

The electrode layer may sense a touch input. The electrode layer may be formed of a transparent conductive layer, for example, a metal, a metal nanowire, a metal oxide, a carbon nanotube, graphene, a conductive polymer, a conductive ink, or the like. As the metal, gold (Au), silver (Ag), copper (Cu), molybdenum (Mo), aluminum (Al), palladium (Pd), Neodymium (Nd), silver-palladium-copper alloy (APC) or the like may be used. As the metal oxide, indium tin oxide (ITO), indium zinc oxide (IZO), indium zinc tin oxide (IZTO), aluminum zinc oxide (AZO), gallium zinc oxide (GZO), fluorine tin oxide (FTO), zinc oxide (ZnO), indium tin oxide-silver-indium tin oxide (ITO-Ag-ITO), indium zinc oxide-silver-indium zinc oxide (IZO-Ag-IZO), indium zinc tin oxide-silver-indium zinc tin oxide(IZTO-Ag-IZTO), aluminum zinc oxide-silver-aluminum zinc oxide (AZO-Ag-AZO), etc. may be used.

When the electrode layer is used for foldable devices, it may be preferable to be formed of a soft conductive material. As the soft conductive material, polyethylenedioxythiophene (PEDOT: poly 3,4-ethylenedioxythiophene), PEDOT:PSS (polystyrene sulfonate), or a mixture of PEDOT:PSS and metal nanowires may be used.

PEDOT:PSS is a polythiophene-based conductive polymer, which is poly(3,4-ethylenedioxythiophene) doped with polystyrene sulfonate (PSS). PEDOT:PSS can be prepared by oxidative polymerization of 3,4-ethylenedioxythiophene (EDOT) in an aqueous solution using PSS as a template for balancing charge. PEDOT:PSS allows PEDOT to be ionic bonded very strongly to the PSS polymer chain. As a result, PEDOT:PSS is not separated from each other in an aqueous solution and can be stably dispersed as polymer gel particles.

Metal nanowires consist of a conductive metal in the form of nano-unit wires. Metal nanowires may be, for example, silver (Ag), gold (Au), copper (Cu), nickel (Ni), platinum (Pt), palladium (Pd), or aluminum (Al) nanowires, or may be core-shell wires with a combination thereof. The nanowires can be connected to each other to act as electrodes. Nanowires can be transparent due to their nano-sized dimension.

It is preferable that the electrode layer has an electrode pattern structure used in a capacitive type. The electrode layer may employ a mutual-capacitance type or a self-capacitance type. In the case of the mutual-capacitance type, it may be a grid pattern with a horizontal axis and a vertical axis. A bridge electrode may be included at an intersection of the electrodes of the horizontal and vertical axes. In the case of the self-capacitance type, it may have a pattern structure in which a change in capacitance is read using one electrode at each point.

The passivation layer insulates and protects the electrode layer. The passivation layer may be formed on the electrode layer and the base layer. The passivation layer may be composed of one or more materials selected from a curable prepolymer, a curable polymer, and a plastic polymer, which are general insulators.

The passivation layer may be made of a varnish-type material capable of forming a film. The varnish-type material may be polysilicon, such as polydimethylsiloxane (PDMS) or polyorganosiloxane (POS), polyimide, or polyurethane, such as spandex. The varnish-type material is a soft insulation material and can increase the stretchability and dynamic folding capability of the touch sensor panel.

By not bonding a separate base film other than the base layer for the touch sensor layer 110, the touch sensor layer 110 may be formed as a thin film layer. Furthermore, at least one of the base layer and the passivation layer may be omitted and replaced with a bonding layer or an adhesive layer in the touch sensor layer 110.

The bonding layer 120 couples the touch sensor layer 110 and the functional layer 140. For the bonding layer 120, one side (lower surface in FIG. 1) may be bonded to one side (upper surface in FIG. 1) of the touch sensor layer 110, and the other side (upper surface in FIG. 1) may be bonded to one side (lower surface in FIG. 1) of the functional layer 140.

The bonding layer 120 may be, for example, a photocurable adhesive. The photocurable adhesive may include a photopolymerizable compound, a photopolymerization initiator, and the like. The photopolymerizable compound may include a radical photopolymerizable compound and/or a cationic photopolymerizable compound.

Examples of the radical photopolymerizable compound include 1 to 6 functional monomers. Specifically, examples of the radical photopolymerizable compound include monofunctional monomers such as methyl (meth)acrylate, allyl methacrylate, 2-ethoxyethyl (meth)acrylate, isodecyl (meth)acrylate, 2-dodecylthioethyl methacrylate, octyl acrylate, 2-methoxyethyl acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, glycidyl (meth)acrylate, tetrafurfuryl (meth)acrylate, phenoxyethyl (meth)acrylate, urethane acrylate, aminoethyl (meth)acrylate, and dimethylaminoethyl (meth)acrylate; bifunctional monomers such as 1,3-butanediol di(meth)acrylate, 1,4-butanediol di(meth)acrylate, 1,6-hexanediol di(meth)acrylate, ethylene glycol di(meth)acrylate, bisphenol A-ethylene glycol diacrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, neopentyl glycol di(meth)acrylate, dicyclopentanyl di(meth)acrylate, caprolactone modified dicyclopentenyl di(meth)acrylate, ethylene oxide modified phosphate di(meth)acrylate, bis(2-hydroxyethyl) isocyanurate di(meth)acrylate, di(acryloxyethyl) isocyanurate, allylated cyclohexyl di(meth)acrylate, dimethyloldicyclopentane diacrylate, ethylene oxide modified hexahydrophthalic acid diacrylate, tricyclodecane dimethanol acrylate, neopentyl glycol modified trimethylolpropane diacrylate, and adamantane diacrylate; trifunctional monomers such as trimethylolpropane tri(meth)acrylate, dipentaerythritol tri(meth)acrylate, propionic acid modified dipentaerythritol tri(meth)acrylate, pentaerythritol tri(meth)acrylate, propylene oxide modified trimethylolpropane tri(meth)acrylate, tris(2-hydroxyethyl) isocyanurate tri(meth)acrylate, tris(acryloxyethyl) isocyanurate, and glycerol tri(meth)acrylate; tetrafunctional monomers such as diglycerin tetra(meth)acrylate, pentaerythritol tetra(meth)acrylate, and ditrimethylolpropane tetra(meth)acrylate; pentafunctional monomers such as propionic acid modified dipentaerythritol penta(meth)acrylate; and hexafunctional monomers such as caprolactone modified dipentaerythritol hexa(meth)acrylate, and 1 to 3 functional monomers are preferred among those above. These can be used alone or in combination of two or more.

Examples of the cationic photopolymerizable compound include bisphenol type epoxy resin such as bisphenol A type epoxy resin and bisphenol F type epoxy resin; novolac type epoxy resin such as phenol novolac type epoxy resin and cresol novolac type epoxy resin; aliphatic epoxy resin, alicyclic epoxy resin, naphthalene type epoxy resin, multifunctional epoxy resin, biphenyl type epoxy resin, glycidyl ether type epoxy resin, glycidyl ester type epoxy resin, glycidylamine type epoxy resin; alcohol type epoxy resin such as hydrogenated bisphenol A type epoxy resin; halogenated epoxy resin such as brominated epoxy resin; epoxy group-containing compound such as rubber modified urethane resin, urethane modified epoxy resin, epoxidized polybutadiene, epoxidized styrene-butadiene-styrene block copolymer, epoxy group-containing polyester resin, epoxy group-containing polyurethane resin, and epoxy group-containing acrylic resin; oxetanyl group-containing compound such as phenoxymethyloxetane, 3,3-bis(methoxymethyl)oxetane, 3,3-bis(phenoxymethyl)oxetane, 3-ethyl-3-(phenoxymethyl)oxetane, 3-ethyl-3-(2-ethylhexyloxymethyl)oxetane, 3-ethyl-3-{[3-(triethoxysilyl)propoxy]methyl}oxetane, phenol novolac oxetane, and 1,4-bis{[(3-ethyl-3-oxetanyl)methoxy]methyl}benzene, and these can be used alone or in combination of two or more.

The photopolymerization initiator improves the efficiency of the curing reaction. Examples of the photoinitiators include radical photopolymerization initiators such as acetophenone-based, benzophenone-based, thioxanthone-based, benzoin-based, and benzoinalkylether-based; aromatic diazonium salts, aromatic sulfonium salts, aromatic iodine aluminum salts, benzoin sulfonic acid esters, and the like. In addition, as cationic photopolymerization initiators, there are commercially available products such as Oputoma-SP-151, Oputoma-SP-170, Oputoma-SP-171 (Asahi Telephone Industry), Igacure-261 (Shiba Corporation), SAN-AID SI-60L, UVI-6990 (Union Carbide), BBI-1C3, MPI-103, TPS-103, DTS-103, NAT-103, NDS-103 (Midori Chemical), CPI-110A (San Epro), etc. These can be used alone or in combination of two or more.

The content of the photopolymerization initiator is not particularly limited, and may be 0.5 to 10 parts by weight based on 100 parts by weight of the photopolymerizable compound. If the content is within the above range, it may have an appropriate curing speed and excellent durability.

Table 1 below shows folding durability and impact resistance measured with a touch sensor layer 110 with a thickness of 10 μm, an adhesive layer 130 with a thickness of 20 μm, a polarizing plate with a thickness of 5μpm as a functional layer 140, and a PI composite film with a thickness of 100 μm (a laminate of 25 μm-thick upper PI layer, 25 μm-thick PSA layer, and 50 μm-thick lower PI layer) as a replica of a display panel 200, while changing the thickness and modulus of the bonding layer 120 (at room temperature, 25° C.). The folding durability was measured as the number of folding until cracks occurred in the touch sensor layer 110 under the condition of a radius of curvature of 3 R. The impact resistance was measured as the weight (g) of the ball at which cracks occurred in the touch sensor layer 110 when the ball was dropped 7 times at a height of 10 cm. If the number of folding is 150,000 or more, the folding durability is evaluated as good, and if it is 190,000 or more, it can be evaluated as optimal. If the ball weight is 30 g or more, the impact resistance is evaluated as good, and if it is 40 g or more, it can be evaluated as optimal.

TABLE 1

| | Bonding Layer | Bonding Layer | Folding | Impact |
|---|---|---|---|---|
| Test | Thickness | Modulus | Durability | Resistance |
| No. | (μm) | (MPa) | (10 thousand times) | (g) |
| 1 | 0.5 | 0.5 | 5 | 20 |
| 2 | | 1 | 8 | 20 |
| 3 | | 2 | 3 | 10 |
| 4 | | 3 | 5 | 10 |
| 5 | 1 | 0.5 | 5 | 20 |
| 6 | | 1 | 15 | 30 |
| 7 | | 2 | 17 | 30 |
| 8 | | 3 | 17 | 30 |
| 9 | 1.5 | 0.5 | 11 | 40 |
| 10 | | 1 | 20 | 40 |
| 11 | | 2 | 20 | 40 |
| 12 | | 3 | 19 | 30 |
| 13 | 2 | 0.5 | 14 | 40 |
| 14 | | 1 | 20 | 40 |
| 15 | | 2 | 20 | 40 |
| 16 | | 3 | 19 | 30 |
| 17 | 2.5 | 0.5 | 12 | 30 |
| 18 | | 1 | 15 | 30 |
| 19 | | 2 | 15 | 30 |
| 20 | | 3 | 15 | 30 |
| 21 | J | 0.5 | 10 | 30 |
| 22 | | 1 | 17 | 30 |
| 23 | | 2 | 15 | 30 |
| 24 | | 3 | 15 | 30 |
| 25 | 3.5 | 0.5 | 8 | 20 |
| 26 | | 1 | 8 | 20 |
| 27 | | 2 | 5 | 20 |
| 28 | | 3 | 1 | 20 |

From Table 1 above, it can be confirmed that the thickness of the bonding layer 120 is in the range of 1 to 3 μm and the modulus thereof is in the range of 1 to 3 MPa to satisfy the condition that the number of folding is 150,000 times or more and the ball weight is 30 g or more in the impact resistance.

In addition, it can be seen that the thickness of the bonding layer 120 is in the range of 1.5 to 2 μm and the modulus thereof is in the range of 1 to 2 MPa to satisfy the condition that the number of folding is 190,000 times or more and the ball weight is 40 g or more in the impact resistance.

The adhesive layer 130 couples the touch sensor layer 110 and the display panel 200. The adhesive layer 130 may have one side (upper surface in FIG. 1) coupled to the other side (lower surface in FIG. 1) of the touch sensor layer 110, and the other side (lower surface in FIG. 1) coupled to one side (upper surface in FIG. 1) of the display panel 200.

For the adhesive layer 130, an adhesive film such as PSA (Pressure Sensitive Adhesive), OCA (Optically Clear Adhesive), or the like may be used.

The adhesive layer 130 may include, for example, an acrylic copolymer, a crosslinking agent, and the like.

The acrylic copolymer may be a copolymer of a (meth)acrylate monomer having an alkyl group having 1-12 carbon atoms and a polymerizable monomer having a crosslinkable functional group.

In the present invention, (meth)acrylate means acrylate and methacrylate. Examples of the (meth)acrylate monomer having an alkyl group having 1-12 carbon atoms include n-butyl (meth)acrylate, 2-butyl (meth)acrylate, t-butyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, nonyl (meth)acrylate, decyl (meth)acrylate, lauryl (meth)acrylate, and the like. These may be used alone or in combination of two or more.

The polymerizable monomer having a crosslinkable functional group may be a component that can impart durability and cuttability by reinforcing the cohesive strength or adhesive strength of the adhesive composition by chemical bonding. The polymerizable monomer having a crosslinkable functional group may include, for example, a monomer having a hydroxy group, and a monomer having an carboxyl group, and these can be used alone or in combination of two or more.

Examples of the monomer having a hydroxy group include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethylene glycol (meth)acrylate, 2-hydroxypropylene glycol (meth)acrylate, hydroxyalkylene glycol (meth)acrylate having 2 to 4 carbon atoms in the alkylene group, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, 10-hydroxydecyl vinyl ether, and the like.

Examples of the monomer having a carboxyl group include monoacids such as (meth)acrylic acid and crotonic acid; diacids such as maleic acid, itaconic acid, and fumaric acid, and monoalkyl esters thereof; 3-(meth)acryloylpropionic acid; succinic anhydride ring-opening adduct of 2-hydroxyalkyl (meth)acrylate having 2 to 3 carbon atoms in the alkyl group, succinic anhydride ring-opening adduct of hydroxyalkylene glycol (meth)acrylate having 2 to 4 carbon atoms in the alkylene group, and compounds obtained by ring-opening addition of succinic anhydride to the caprolactone adduct of 2-hydroxyalkyl (meth)acrylate having 2 to 3 carbon atoms in the alkyl group.

The acrylic copolymer may further contain other polymerizable monomers in addition to the above monomers in a range that does not decrease the adhesive strength, for example, 10 wt % or less based on the total amount.

The method for producing the copolymer is not particularly limited. It can be prepared using a method commonly used in the art such as bulk polymerization, solution polymerization, emulsion polymerization or suspension polymerization, and solution polymerization is preferred. In addition, solvents, polymerization initiators, chain transfer agents for molecular weight control, etc., which are usually used in polymerization, can be used.

The acrylic copolymer preferably has a weight average molecular weight (in terms of polystyrene, Mw) of 50,000 to 2,000,000 measured by gel permeation chromatography (GPC), and more preferably 400,000 to 2,000,000. When the weight average molecular weight is less than 50,000, cohesion between copolymers is insufficient, which may cause adhesion durability problems. When it exceeds 2,000,000, a large amount of diluting solvent may be required to ensure processability during coating.

The crosslinking agent is a component capable of improving adhesion and durability, and maintaining reliability and shape of an adhesive at high temperatures. An isocyanate-based, epoxy-based, peroxide-based, metal chelate-based, oxazoline-based, or the like may be used as the crosslinking agent, and these can be used alone or in combination of two or more. Among these, isocyanate-based is preferable. Specifically, diisocyanate compounds such as tolylene diisocyanate, xylene diisocyanate, hexamethylene diisocyanate, and 2,4- or 4,4-diphenylmethane diisocyanate; and adducts of polyhydric alcohol-based compounds such as trimethylolpropane of diisocyanate, etc. may be used.

In addition to the isocyanate crosslinking agent, at least one crosslinking agent selected from the group consisting of melamine derivatives such as hexamethylolmelamine, hexamethoxymethylmelamine, and hexabutoxymethylmelamine; polyepoxy compounds such as bisphenol A and epichlorohydrin condensed epoxy compounds; and polyglycidyl ether of polyoxyalkylene polyol, glycerin di- or triglycidyl ether, and tetraglycidyl xylenediamine may be added and used together.

Table 2 below shows folding durability and impact resistance measured with a touch sensor layer 110 with a thickness of 10 μm, a bonding layer 120 with a thickness of 2 μm, a polarizing plate with a thickness of 50 μm as a functional layer 140, and a PI composite film with a thickness of 100 μm (a laminate of 25 μm-thick upper PI layer, 25 μm-thick PSA layer, and 50 μm-thick lower PI layer) as a replica of a display panel 200, while changing the thickness and modulus of the adhesive layer 130 (at room temperature, 25° C.). The folding durability was measured as the number of folding until cracks occurred in the touch sensor layer 110 under the condition of a radius of curvature of 3 R. The impact resistance was measured as the weight (g) of the ball at which cracks occurred in the touch sensor layer 110 when the ball was dropped 7 times at a height of 10 cm. If the number of folding is 150,000 or more, the folding durability is evaluated as good, and if it is 190,000 or more, it can be evaluated as optimal. If the ball weight is 30 g or more, the impact resistance is evaluated as good, and if it is 40 g or more, it can be evaluated as optimal.

TABLE 2

| | Adhesive Layer | Adhesive Layer | Folding | Impact |
|---|---|---|---|---|
| Test | Thickness | Modulus | Durability | Resistance |
| No. | (μm) | (MPa) | (10 thousand times) | (g) |
| 1 | 5 | 0.02 | 11 | 10 |
| 2 | | 0.1 | 11 | 20 |
| 3 | | 0.2 | 11 | 10 |
| 4 | | 0.3 | 7 | 20 |
| 5 | | 0.4 | 10 | 10 |
| 6 | | 0.5 | 5 | 10 |
| 7 | | 0.6 | 8 | 10 |
| 8 | 10 | 0.02 | 13 | 20 |
| 9 | | 0.1 | 11 | 20 |
| 10 | | 0.2 | 10 | 10 |
| 11 | | 0.3 | 9 | 20 |
| 12 | | 0.4 | 9 | 10 |
| 13 | | 0.5 | 8 | 20 |
| 14 | | 0.6 | 9 | 20 |
| 15 | 15 | 0.02 | 20 | 40 |
| 16 | | 0.1 | 20 | 40 |
| 17 | | 0.2 | 19 | 40 |
| 18 | | 0.3 | 19 | 40 |
| 19 | | 0.4 | 16 | 30 |
| 20 | | 0.5 | 17 | 30 |
| 21 | | 0.6 | 10 | 30 |
| 22 | 20 | 0.02 | 20 | 40 |
| 23 | | 0.1 | 20 | 40 |
| 24 | | 0.2 | 20 | 40 |
| 25 | | 0.3 | 20 | 40 |
| 26 | | 0.4 | 17 | 40 |
| 27 | | 0.5 | 16 | 30 |
| 28 | | 0.6 | 13 | 30 |
| 29 | 25 | 0.02 | 20 | 40 |
| 30 | | 0.1 | 20 | 40 |
| 31 | | 0.2 | 20 | 40 |
| 32 | | 0.3 | 20 | 40 |
| 33 | | 0.4 | 18 | 40 |
| 34 | | 0.5 | 15 | 40 |
| 35 | | 0.6 | 11 | 40 |
| 36 | 30 | 0.02 | 18 | 30 |
| 37 | | 0.1 | 18 | 40 |
| 38 | | 0.2 | 17 | 30 |
| 39 | | 0.3 | 15 | 40 |
| 40 | | 0.4 | 16 | 40 |
| 41 | | 0.5 | 15 | 30 |
| 42 | | 0.6 | 13 | 30 |
| 43 | 35 | 0.02 | 15 | 30 |
| 44 | | 0.1 | 17 | 40 |
| 45 | | 0.2 | 17 | 30 |
| 46 | | 0.3 | 15 | 30 |
| 47 | | 0.4 | 16 | 30 |
| 48 | | 0.5 | 15 | 30 |
| 49 | | 0.6 | 13 | 40 |
| 50 | 40 | 0.02 | 12 | 30 |
| 51 | | 0.1 | 11 | 20 |
| 52 | | 0.2 | 13 | 20 |
| 53 | | 0.3 | 10 | 30 |
| 54 | | 0.4 | 9 | 30 |
| 55 | | 0.5 | 8 | 30 |
| 56 | | 0.6 | 9 | 30 |
| 57 | 45 | 0.02 | 13 | 30 |
| 58 | | 0.1 | 13 | 40 |
| 59 | | 0.2 | 8 | 40 |
| 60 | | 0.3 | 7 | 20 |
| 61 | | 0.4 | 8 | 20 |
| 62 | | 0.5 | 8 | 10 |
| 63 | | 0.6 | 5 | 20 |

From Table 2 above, it can be confirmed that the thickness of the adhesive layer 130 is in the range of 15 to 35 μm and the modulus thereof is in the range of 0.02 to 0.5 MPa to satisfy the condition that the number of folding is 150,000 times or more and the ball weight is 30 g or more in the impact resistance.

In addition, it can be seen that the thickness of the adhesive layer 130 is in the range of 15 to 25 μm and the modulus thereof is in the range of 0.02 to 0.3 MPa to satisfy the condition that the number of folding is 190,000 times or more and the ball weight is 40 g or more in the impact resistance.

The functional layer 140 has one side (lower surface in FIG. 1) coupled to the other side (upper surface in FIG. 1) of the bonding layer 120. The functional layer 140 may be a transparent film, a polarizing plate, or the like.

The transparent film may be an isotropic film, a retardation film, a protective film, or the like. The transparent film may contain one or more additives. Examples of the additive may include an UV absorber, an antioxidant, a lubricant, a plasticizer, a releasing agent, a coloring-preventing agent, an anti-flame agent, a nucleating agent, an anti-static agent, a pigment and a colorant. The transparent film may comprise various functional layers including a hard coating layer, an anti-reflective layer and a gas barrier layer on one surface or both surfaces thereof.

The polarizing plate may be any one known to be used in a display device. As the polarizing plate, for example, those in which a protective layer is formed on at least one surface of a polarizer dyed with iodine or a dichroic dye after stretching a polyvinyl alcohol film, a liquid crystal aligned to have the performance of a polarizer, a transparent film coated with an oriented resin such as polyvinyl alcohol, and then stretched and dyed, or the like may be used.

Table 3 below shows folding durability and impact resistance measured with a touch sensor layer 110 with a thickness of 10 μm, a bonding layer 120 with a thickness of 2 μm, an adhesive layer 130 with a thickness of 20 μm, a PI composite film with a thickness of 100 μm (a laminate of 25 μm-thick upper PI layer, 25 μm-thick PSA layer, and 50 μm-thick lower PI layer) as a replica of a display panel 200 and a polarizing plate as a functional layer 140, while changing the thickness and modulus of the functional layer 140 (at room temperature, 25° C.). The folding durability was measured as the number of folding until cracks occurred in the touch sensor layer 110 under the condition of a radius of curvature of 3 R. The impact resistance was measured as the weight (g) of the ball at which cracks occurred in the touch sensor layer 110 when the ball was dropped 7 times at a height of 10 cm. If the number of folding is 150,000 or more, the folding durability is evaluated as good, and if it is 190,000 or more, it can be evaluated as optimal. If the ball weight is 30 g or more, the impact resistance is evaluated as good, and if it is 40 g or more, it can be evaluated as optimal.

TABLE 3

| | Functional Layer | Folding | Impact |
|---|---|---|---|
| Test | Thickness | Durability | Resistance |
| No. | (μm) | (10 thousand times) | (g) |
| 1 | 5 | 12 | 10 |
| 2 | 15 | 15 | 30 |
| 3 | 25 | 16 | 30 |
| 4 | 35 | 20 | 40 |
| 5 | 45 | 20 | 40 |
| 6 | 55 | 19 | 40 |
| 7 | 65 | 17 | 30 |
| 8 | 75 | 17 | 30 |
| 9 | 85 | 10 | 10 |

From Table 3 above, it can be confirmed that the thickness of the functional layer 140 is in the range of 15 to 75 μm to satisfy the condition that the number of folding is 150,000 times or more and the ball weight is 30 g or more in the impact resistance.

In addition, it can be seen that the thickness of the functional layer 140 is in the range of 35 to 55 μm to satisfy the condition that the number of folding is 190,000 times or more and the ball weight is 40 g or more in the impact resistance.

A display panel according to the present invention may further include a display panel 200 coupled to the foldable touch sensor panel described above through an adhesive layer 130 therebetween.

The display panel 200 is a device that displays information or an image. The display panel 200 may include a liquid crystal display panel, a plasma panel, an electroluminescent panel, an organic light emitting diode panel, and the like. The preferred embodiments of the present invention have been described with reference to the drawings. However, the present invention is not limited to the above-described embodiment, and it will be understood that the present invention can be implemented in a modified form without departing from the essential characteristics of the present invention.

Therefore, the scope of the present invention is defined by the claims rather than the foregoing description, and all differences within the equivalent range should be interpreted as being included in the present invention.

[Description of reference numerals]

| | |
|---|---|
| 110: touch sensor layer | 120: bonding layer |
| 130: adhesive layer | 140: functional layer |
| 200: display panel | |

1. A foldable touch sensor panel comprising:
a touch sensor layer;
a bonding layer having one side coupled to one side of the touch sensor layer and the other side coupled to a functional layer; and
an adhesive layer having one side coupled to the other side of the touch sensor layer and the other side coupled to a display panel.

2. The foldable touch sensor panel according to claim 1, wherein the bonding layer has a modulus of 1 to 3 MPa at room temperature (25° C.) and a thickness of 1 to 3 μm.

3. The foldable touch sensor panel according to claim 2, wherein the bonding layer has a modulus of 1 to 2 MPa at room temperature (25° C.) and a thickness of 1.5 to 2 μm.

4. The foldable touch sensor panel according to claim 1, wherein the adhesive layer has a modulus of 0.02 to 0.5 MPa at room temperature (25° C.) and a thickness of 15 to 35 μm.

5. The foldable touch sensor panel according to claim 4, wherein the adhesive layer has a modulus of 0.02 to 0.3 MPa at room temperature (25° C.) and a thickness of 15 to 25 μm.

6. The touch sensor panel according to claim 1, wherein the functional layer is a polarizing plate and has a thickness of 15 to 75 μm.

7. The touch sensor panel according to claim 6, wherein the functional layer has a thickness of 35 to 55 μm.

8. A display device comprising:
the foldable touch sensor panel according to claim 1; and
a display panel coupled to the other side of the adhesive layer of the foldable touch sensor panel.

9. A display device comprising:
the foldable touch sensor panel according to claim 2; and
a display panel coupled to the other side of the adhesive layer of the foldable touch sensor panel.

10. A display device comprising:
the foldable touch sensor panel according to claim 3; and
a display panel coupled to the other side of the adhesive layer of the foldable touch sensor panel.

11. A display device comprising:
the foldable touch sensor panel according to claim 4; and
a display panel coupled to the other side of the adhesive layer of the foldable touch sensor panel.

12. A display device comprising:
the foldable touch sensor panel according to claim 5; and
a display panel coupled to the other side of the adhesive layer of the foldable touch sensor panel.

13. A display device comprising:
the foldable touch sensor panel according to claim 6; and
a display panel coupled to the other side of the adhesive layer of the foldable touch sensor panel.

14. A display device comprising:
the foldable touch sensor panel according to claim 7; and
a display panel coupled to the other side of the adhesive layer of the touch sensor panel.
